(19) United States
(12) Patent Application Publication
(10) Pub. No.: US 2017/0053335 A1
(43) Pub. Date: Feb. 23, 2017

(54) SYSTEMS AND METHODS FOR SIZING SHOES

(71) Applicants: Andrew HANSCOM, Newport Beach, CA (US); vFit Technologies Inc., Newport Beach, CA (US)

(72) Inventor: Andrew Hanscom, Newport Beach, CA (US)

(21) Appl. No.: 15/118,662

(22) PCT Filed: Feb. 13, 2015
(86) PCT No.: PCT/US2015/015813

§ 371 Date: Aug. 12, 2016

Related U.S. Application Data
(60) Provisional application No. 61/939,825, filed on Feb. 14, 2014.

(51) Int. Cl. G06Q 30/06; G06Q 10/06; A43D 1/02

(52) U.S. Cl. CPC G06Q 30/0631; A43D 1/025; A43D 1/027; G06Q 30/0643; G06Q 10/067; G06Q 30/0627; G06F 17/50

(57) ABSTRACT

Capturing three-dimensional images of feet and arraying them against vast databases of stored shoe data enables better developed matching with desired fittings than conventional systems. Smartphone/iPhone/digital camera and related interface tools supported by proprietary data streams and engines recommend better shoe choices from plethoric offerings updated continually and based upon legacy shoe data along with new ways to compare and select shoes.

### CROSS-REFERENCE TO RELATED APPLICATION

This application claims priority to, and the benefit of, U.S. Provisional Application Ser. No. 61/939,825, filed Feb. 14, 2014, the contents of which are incorporated by reference.

### BACKGROUND

Shoes that do not fit right can cause significant discomfort and pain. This creates commercial challenges for shoe sellers and manufacturers. If a buyer is unhappy with his shoes, he might not purchase that brand again—leading to a loss of potential revenue—or he might return the shoes. If returned shoes exhibit too much wear, they cannot be resold, which is a costly loss to a manufacturer.

In-store shoe fitting has been around for decades, and it involves measuring the length and width of a person's foot. Unfortunately, those two measurements do not provide nearly enough information to match a customer's foot to those few certain shoes, out of all of the thousands of brands and styles on the market, that would have a great fit for the person. Moreover, with the advent of online shopping, fewer people go to brick-and-mortar shoe stores anymore. Online shoppers simply hope that the size number for their most recent comfortable fit represents a good guess as to what will fit well when ordering from a website. But since different styles and makes of shoes fit differently despite their printed size number, even savvy online shoppers often find that their shoe purchases do not fit right.

### SUMMARY

The invention provides systems and methods for evaluating a person's foot shape and size and recommending shoes with manufactured dimensions that match the person's foot, thus ensuring a good fit. The person can take a plurality of images of their foot using, for example, a smartphone app of the invention. The plurality of images is transformed into one or more sets of 3D coordinates representing that person's foot. A fitting model may be applied to the coordinates to adjust certain parameters or to introduce allowed tolerances. The final coordinate set is matched to a database of shoe lasts, in which each digitally modeled last is linked to manufacturers, brands, or styles that are built to that last. Based on the matched virtual last, a recommendation engine recommends shoe models that will exhibit excellent fit and comfort for that person.

Additionally, where a shoe model is not represented by a virtual last in the database, the invention provides systems and methods for creating a virtual last for the shoe. For example, a manufacturer may not provide a digital last model for use with systems and methods of the invention. In such an instance, fit information is collected from a plurality of people that wear the shoe model in question. The multiple sets of different fit information are averaged by a database engine and a virtual last is built based on the averaged or aggregated input from the plurality of owners. The virtual last is then accessioned into the database and associated with the model of shoe for which it was created, as well as with manufacturer information, size information, market information, or any other suitable information.

The present inventions relate to supporting retail shoe purchase by online/digital (one-time) sizing and fitting. The present inventions related specifically to getting better information for purchasing shoes for optimized fitting. Specifically, the instant inventions relate to using actual data streams to optimize remote fitting of shoes and related articles. Traditional retail purchase of shoes has been augmented by online resources and has morphed into combinations of legacy kiosk-types of foot-imaging and with the advent of the instant teachings modern smart-device technologies for capturing and harmonizing images.

The instant teachings update and address the longstanding need to be able to acquire shoes from various makers that best match a user's feet.

Briefly stated, capturing three-dimensional images of feet and arraying them against vast databases of stored shoe data enables better developed matching with desired fittings than conventional systems. Smartphone/iPhone/digital cameras and related interface tools supported by proprietary data streams and engines recommend better shoe choices from plethoric offerings updated continually and based upon legacy shoe data along with new ways to compare and select shoes is disclosed.

According to embodiments, there is provided an improved system for matching a user's feet with recommended shoes, comprising, in combination; providing means for grouping continuous coordinates of a three-dimensional coordinate system into one or more groups (comfort zones); arraying said groups by tolerances generated from pre-existing shoe data and actual foot dimensions; matching tolerance values; and, delivery recommendations for shoe style and preferred size to a user.

According to embodiments, there is provided a process for matching feet to shoe contours, which comprises; harvesting customer foot sizing data and feedback through a web interface tool; comparing the same to a database of actual 3D shoe data; and, deriving choices for shoe models allowing for better matched fit.

According to embodiments, there is provided an advanced recommendation engine fueled by an algorithm for comparing shoe last data to a user's/customer's digital foot data as claimed above or below and in this application.

According to embodiments, there is provided a recommendation engine comprising: means for surveying arrayed shoe data against customer/user's foot data, as described herein and claimed herein or in any U.S. Letters Patent referred to herein.

According to embodiments, there is provided a database which comprises, in combination; a multiplicity of actual shoe last data representing the inside contour of a shoe, digitally stored, arrayed and effective to compare with the exact outside contour of a specific customer/user's feet digitally scanned.

In certain aspects, the invention provides a method for creating a virtual last for a shoe. The method includes collecting, from a plurality of people, input sets of fit information describing a certain shoe model, storing the input sets in a computer system comprising a processor coupled to a memory device, and having the processor merge the input sets to create a digital fit model of the shoe model. A database entry for the shoe model is created in a database within the memory and the digital fit model is saved as a virtual last model in the database entry. The merging step may include having the processor average the fit information of the input sets. The method my further include obtaining information that a plurality of different shoes are built to one last and, for each of the plurality of different shoes, saving the digital fit model as a virtual last model in a database entry for that shoe. Preferably, the input sets comprise comfort ratings for different regions of a foot. In some embodiments, the method includes screening the collected input sets for an outlier and excluding an outlier from the merge step.

In related aspects, the invention provides a system for creating a virtual last for a shoe. The system includes a processor coupled to a memory having stored therein instructions executable to cause the system to collect—from a plurality of people—input sets of fit information describing a certain shoe model, store the input sets in the memory, and merge the input sets to create a digital fit model of the shoe model. The system can create a database entry for the shoe model in a database within the memory and save the digital fit model as a virtual last model in the database entry. The processor may average the fit information of the input sets for the merging. The system may obtain information that a plurality of different shoes are built to one last and—for each of the plurality of different shoes—save the digital fit model as a virtual last model in a database entry for that shoe. The input sets may include comfort ratings for different regions of a foot. The system may screen the collected input sets for an outlier and exclude an outlier from the merge.

In other aspects, the invention provides a method for recommending a shoe. The method includes obtaining digital data describing a foot of a person and storing the digital data in a computer system comprising a processor coupled to a memory, causing the processor to match the digital data to a digital last model stored in a database, and recommending at least one shoe model associated with the digital last to the person.

In some embodiments, the processor matches the digital data by converting the digital data into a set of 3D coordinates and applying a set of tolerances data to an algorithm for comparing the 3D coordinates to dimensions of digital last models. In certain embodiments, obtaining the digital data includes providing instructions and an app for execution on a smartphone or tablet to the person—the instructions instructing the person to take a plurality of pictures of his or her foot—and receiving the digital data from the smartphone, the digital data having been obtained by the person following the instructions. The processor may transform the digital data into a set of 3D coordinates describing the foot. In certain embodiments, the database includes a plurality of database entries for a corresponding plurality of shoes, each database entry comprising a digital last model, and the method further comprises receiving region-of-foot-specific comfort feedback from a plurality of different consumers and adjusting the database entries according to the comfort feedback prior to causing the processor to match the digital data.

Relates aspects of the invention provide a system for recommending a shoe. The system includes a processor coupled to a memory and operable to obtain digital data describing a foot of a person, store the digital data in the memory, match the digital data to a digital last model stored in a database, and recommend at least one shoe model associated with the digital last to the person. The processor matches the digital data by, e.g., converting the digital data into a set of 3D coordinates and applying a set of tolerances data to an algorithm for comparing the 3D coordinates to dimensions of digital last models. Preferably, the system is operable to obtain the digital data by providing instructions and an app for execution on a smartphone to the person, the instructions instructing the person to take a plurality of pictures of his or her foot; and receiving the digital data from the smartphone, the digital data having been obtained by the person following the instructions. The processor may transform the digital data into a set of 3D coordinates describing the foot.

### BRIEF DESCRIPTION OF THE FIGURES

FIG. 1 diagrams a process for recommending a shoe for best fit.

FIG. 2 shows a device for obtaining coordinates.

FIG. 3 illustrates a step of the process.

FIG. 4 shows adding a checkerboard pattern to the white space done invisibly through software.

FIG. 5 illustrates video capture.

FIG. 6 provides detail about obtaining 3D coordinates.

FIG. 7 shows an aggregated number of different perspectives.

FIG. 8 illustrates a web interface for obtaining customer feedback on comfort and fit.

FIG. 9 illustrates a last model as referenced during a matching step.

FIG. 10 illustrates recommending a shoe according to some embodiments.

FIG. 11 shows a system for making shoe recommendations.

FIG. 12 gives a schematic view of components of the system.

FIG. 13 diagrams a method of creating a virtual last for the shoe.

FIG. 14 illustrates an interface for creating a new last record.

FIG. 15 illustrates how data about a shoe fit may be obtained.

FIG. 16 shows foot models from different people.

FIG. 17 shows a merged foot model.

FIG. 18 shows the results of creating the new virtual last.

FIG. 19 illustrates populating database entries for a plurality of shoes.

### DETAILED DESCRIPTION

The present inventor has pioneered the creation of databases of operationally key data points with respect to manufacturer and brand-created footwear, and to facilitate and affect systems to enable selection of those choices best matching customers' feet. Using proprietary methods along with this empirically generated and stored database collection, systems, processes and methodologies have been established to compare, for example, digital scans of customers' feet with manufacturer-generated shoe last data, among other things. U.S. Pat. Nos. 6,741,728; 6,546,356; and 6,549,639 are incorporated by reference.

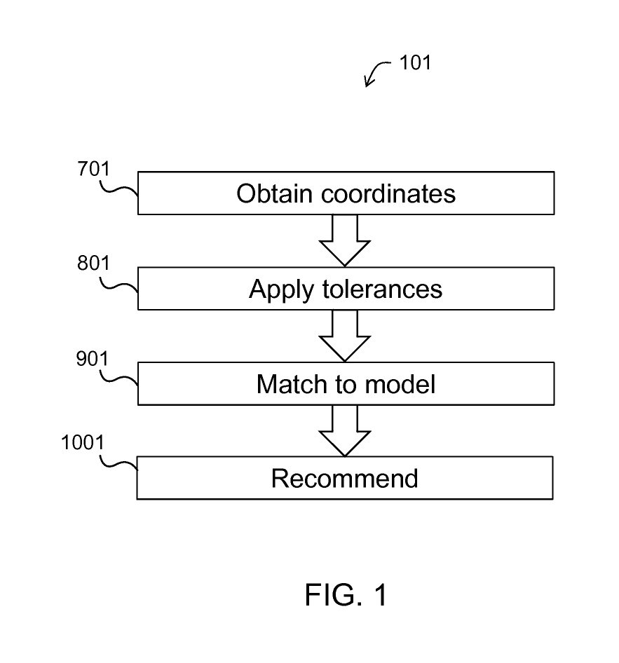

FIG. 1 diagrams a process 101 for recommending a shoe for best fit.

Recommendation process 101 includes obtaining 701 coordinates describing a person's foot, applying 801 any required tolerance to the coordinates, and matching 901 the finalized coordinate set to a model in a database. Based on a successful match, one or a plurality of best-fit shoes is recommended 1001.

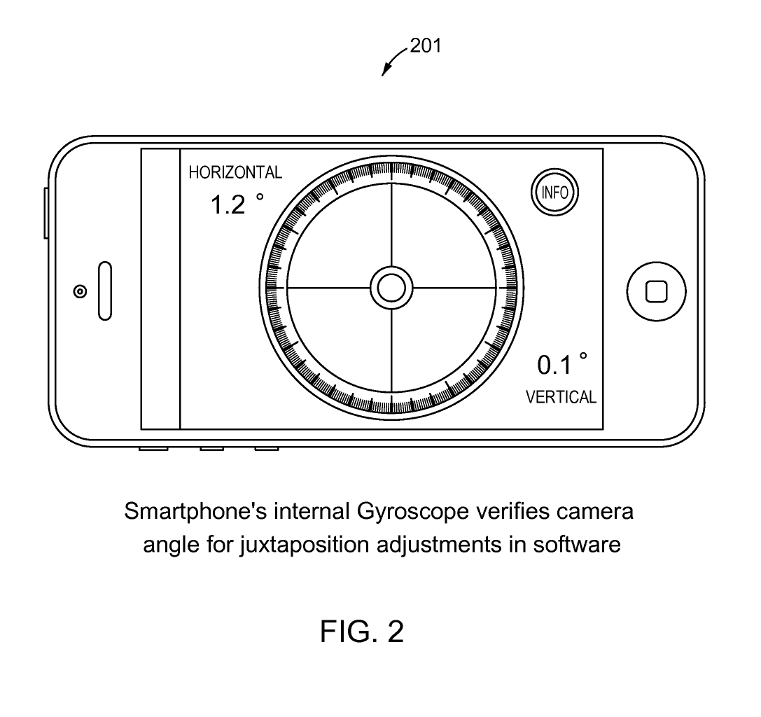

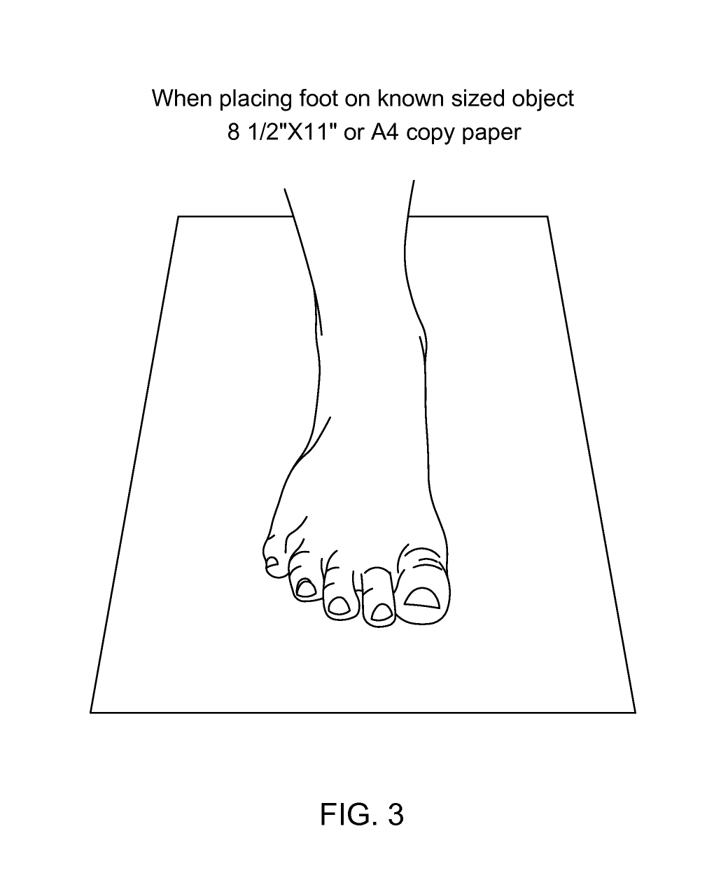

FIG. 2 shows a device 201 for obtaining coordinates. As shown in FIG. 2, device 201 is provided as a smart phone such as an iPhone or Samsung Galaxy. Device 201 may alternatively be provided by a specialized device such as a kiosk, a handheld device with a custom form-factor, or a digital camera with a specialized software package. FIGS. 3-9 will show the use of device 201 to obtain a 3D coordinate model of a person's foot.

FIG. 3 illustrates a first step of process 101. A person places their foot against a background that includes an object of known dimensions. For example, the person may stand on a sheet of 8.5×11 (or A4) paper. The person will train a camera of device 201 onto his or her foot.

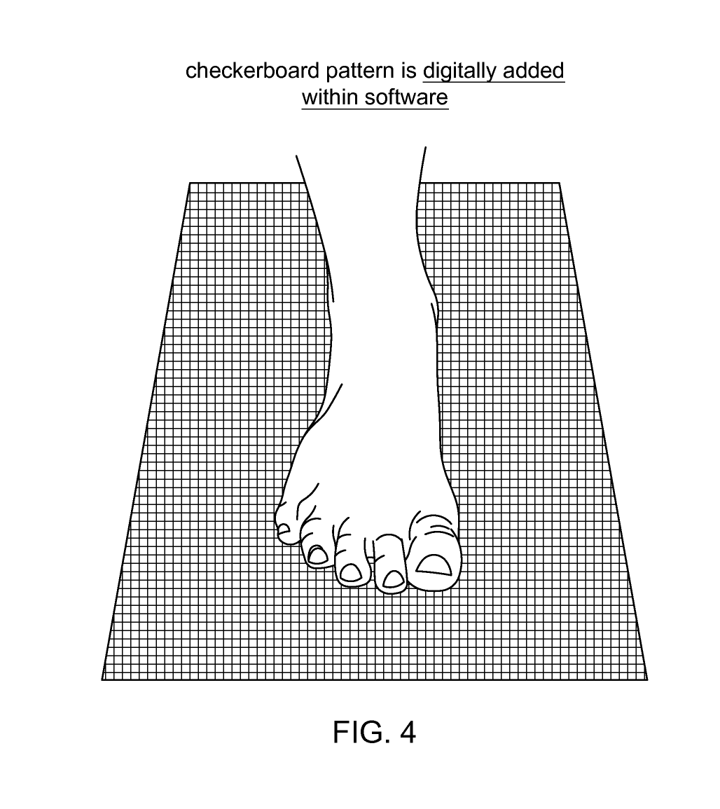

FIG. 4 shows that a system of the invention digitally adds a checkerboard pattern into the white space provided by the template sheet of paper. The checkerboard pattern seeds an arbitrary 3D coordinate system that will be referenced when working with video capture data.

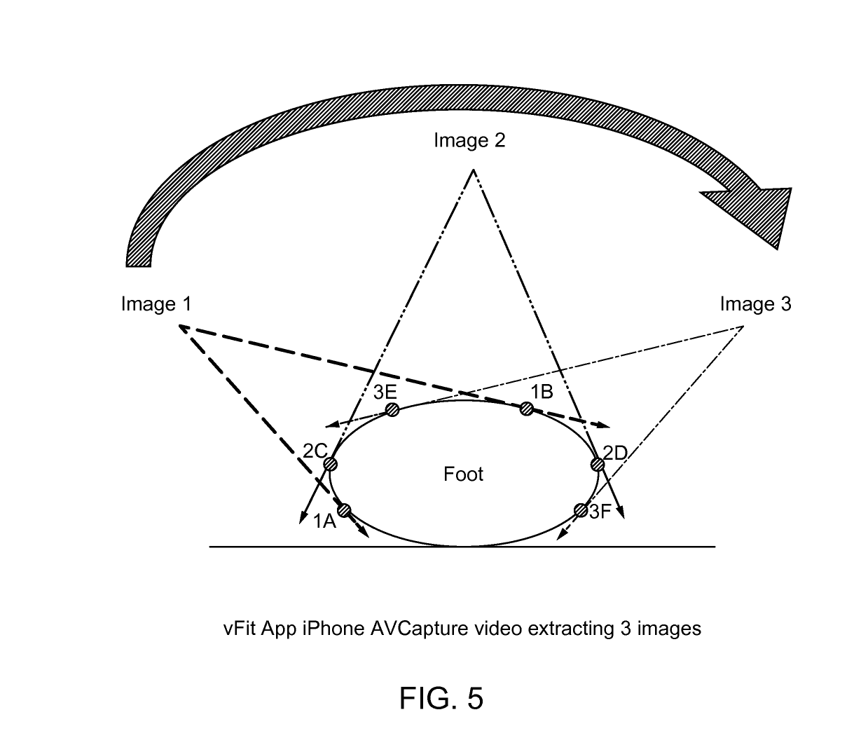

FIG. 5 illustrates video capture. The person follows instructions provided by the smartphone app or accompanying literature and pans a camera of device 201 over his or her foot. The system extracts a plurality of images—e.g., image 1, image 2, and image 3—from the resulting data.

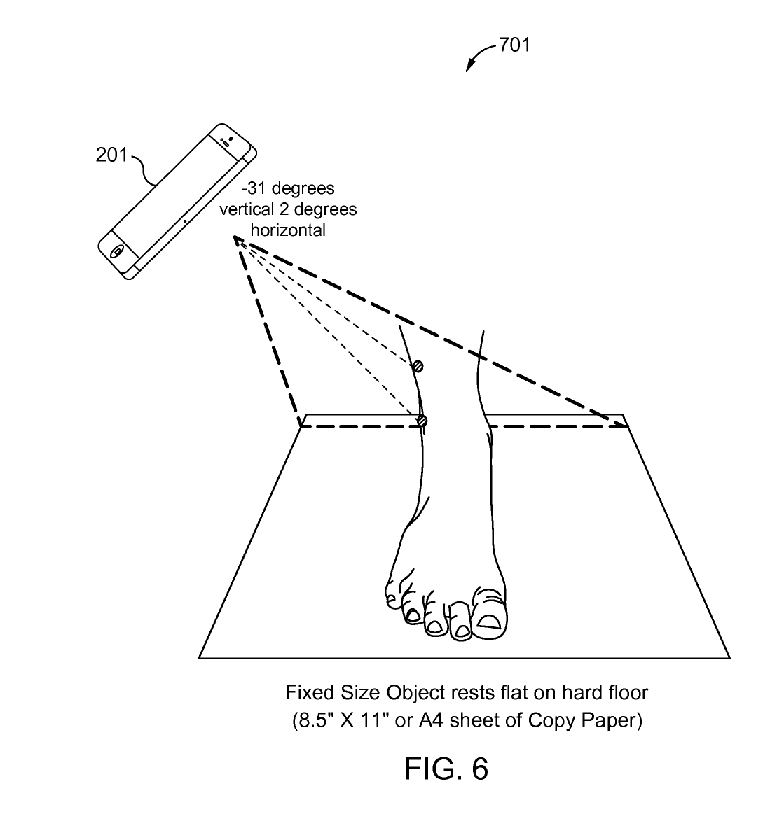

FIG. 6 provides more detail about obtaining 701 the 3D coordinates describing the person's foot. Internal gyroscopes, accelerometers, other hardware, or combinations thereof within device 201 provide orientation information about the images being captured. Following provided instructions, the person pans and/or sweeps the device 201 through a plurality of different positions and orientation.

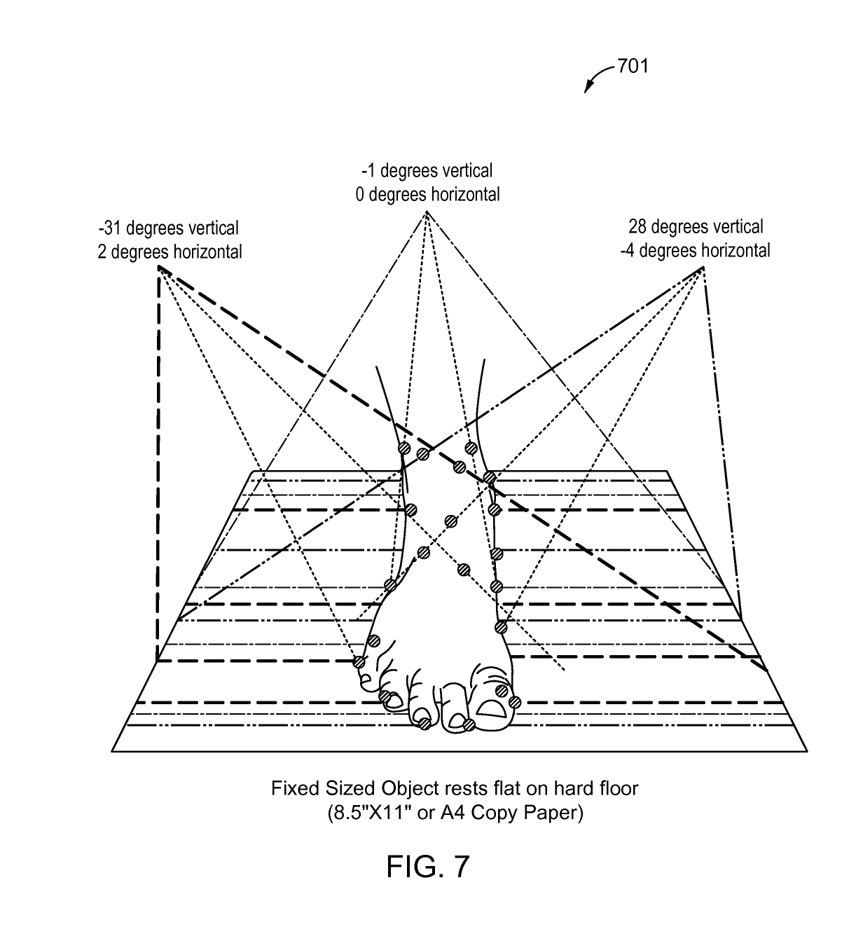

FIG. 7 shows an aggregated number of different perspective from which device 201 may take images to be provided to a system of the invention. Each image is associated with the perspective from which it was obtained and the relevant perspective information, which may be for example defined in degrees from vertical and/or horizontal in three dimensions.

As illustrated in FIG. 7, each image provides a plurality of points within a 3D coordinate system. The digitally-added checkerboard background is used (point locations in x, y, and/or z directions are “counted off” from an arbitrary origin) to determine where the point lies. (As used herein, x, y, and z are arbitrary orthogonal axes with z normal to the sheet of paper or other reference object and y extending along the longest length of the foot.) Geometric calculations using the incline angle of the image can finalize the coordinates for each point. (E.g., within a plane y, one point appears at some degree theta from z in image 1 and at some degree theta′ from z in image 2; tan(theta) and tan(theta′) each give a ratio of z value to x value, where x0 and z0 are known by device 201 for a position from which each image was taken, only one set of values of x and z for the one point will give the correct geometric calculation results—those are the x and z values of the point). The calculations are performed for every point in the dataset. In FIG. 7, 21 points are illustrated for clarity. However, dozens, hundred, thousands, or any number of points may be determined. The resulting set of calculated points provides a model of the person's foot in the form of a set of 3D coordinates within the 3D coordinate system originally defined by the checkerboard background (see FIG. 4). Typically, after the 3D coordinates are determined relative to the checkerboard background of FIG. 4, a transformation into a global 3D coordinate system is made. In a sense, the coordinates are normalized into an arbitrary 3D coordinate system shared for all users and last models within the system.

Embodiments of the invention additionally may “fill in” the 3D coordinate set to create a contiguous set of 3D coordinates. Any suitable approach can be used to fill in the set (i.e., to go from a cloud of dots to a volumetric model). For example, a polygonal fill-in can draw lines between nearest-neighbor coordinates. In some embodiments, a polygon is modeled centered on each coordinate. Either of those two approaches can be used to create a “wire-frame” or mesh model. Other methods of skinning a 3D model are known in the art and may be used.

In some embodiments, the process 101 includes grouping contiguous coordinates of the 3D coordinate system in to one or more groups of contiguous coordinates as comfort zones. One or more sets of tolerances may be applied 801 to the contiguous coordinates. The tolerances for each respective coordinate within a comfort zone preferably have identical tolerance values. In some embodiments, the values are derived by actual multiple customer feedback.

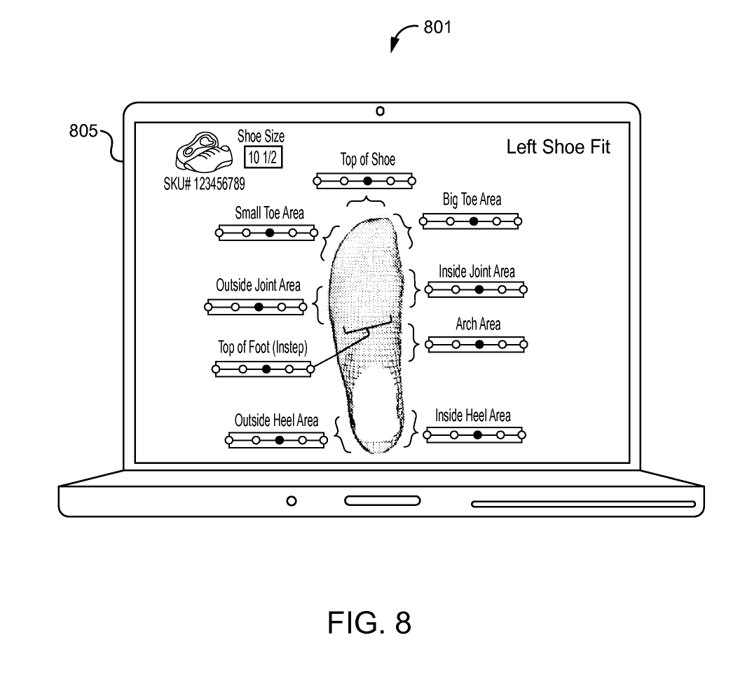

FIG. 8 illustrates a web interface 805 for obtaining customer feedback for specific footwear. The depicted web interface tool 805 is connected to the database that allows for an actual person who's feet dimensions are stored in the database to provide feedback related to the relative comfort of a specific style of footwear stored in the database. Preferably, the feedback is provided for a plurality of specific zones where the shoe style and printed size where the shoe is too loose or too tight on a scale of 1-10. Note that the tolerances may be collected and applied independently of (and either before, after, or simultaneously with) obtaining 701 the coordinates described above.

The premise of this true users' feedback is to improve the understanding of the actual stretch characteristics of individual shoe styles related to the actual stored outside contours of the individual's feet. By using multiple instances of feedback grouped together as continual points, the tolerance results become more accurate as feedback is collected. A standard statistical deviation is applied to the results, so that any information that is provided inaccurately will fall outside of the usable data and will, therefore, be discarded.

In addition to processing and using tolerance data, the system is operable to match 901 the obtained 701 coordinates to models of shoes stored in a database.

The system uses a combination of actual 3D shoe last data, representing the inside contour of a shoe and matching that to the exact outside contour of the specific customers' feet provided by digital scans/images data. A feedback loop is added, which provides true and factual results of stretch characteristics of materials and stitching of specific shoe styles. The result is a highly accurate recommendation database engine, which can provide customers who have provided their own individual foot scans/images an accurate fit and size recommendation 131 for shoe styles they desire to buy through internet retailers, without physically trying them on.

In particular and in some embodiments, each make and model of shoe profiled within the database is represented by its digital last plus any tolerances data. The digital last gives a 3D model of an idealized physical last on which the shoe was manufactured. Preferably, the digital last is “rigid” in that the 3D model is inflexible. This is so that the lasts as modeled within the database can be provided directly by the manufacturers, who may typically be found to provide so-called rigid last models (as the last models are actual CAD or similar models of objects that are manufactured to be rigid).

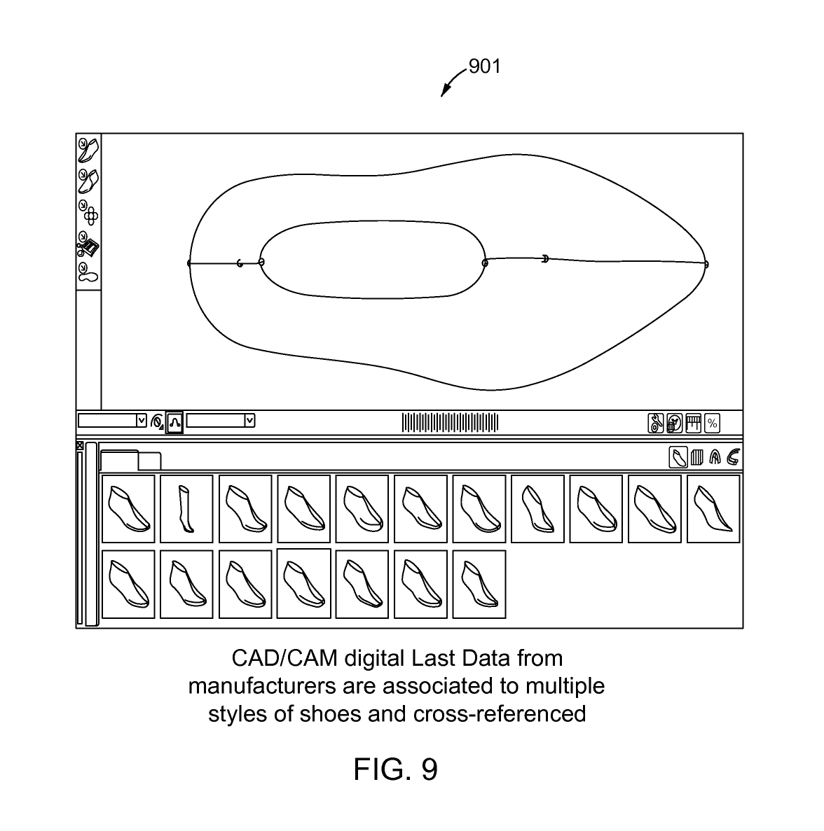

FIG. 9 illustrates a last model as referenced during a matching 901 step of the process 101. The rigid last models are augmented within each database entry by any tolerances information including comfort scores for each of a plurality of regions on the foot. Thus, two very different shoes that are built to the same last may provide very different matching 901 results due to the tolerances data. E.g., where one shoe has a very thick sole and is inflexible around the ball-of-foot region, it may receive adverse comfort scores for that region and only match customer foot models that would leave a little extra free space around that region.

The invention provides systems and methods for evaluating a person's foot shape and size and recommending shoes with manufactured dimensions that match the person's foot, thus ensuring a good fit. The person can take a plurality of images of their foot using, for example, a smartphone app of the invention. The plurality of images is transformed into one or more sets of 3D coordinates representing that person's foot. A fitting model may be applied to the coordinates to adjust certain parameters or to introduce allowed tolerances. The final coordinate set is matched to a database of shoe lasts, in which each digitally modeled last is linked to manufacturers, brands, or styles that are built to that last. Based on the matched virtual last, a recommendation engine recommends 1001 shoe models that will exhibit excellent fit and comfort for that person.

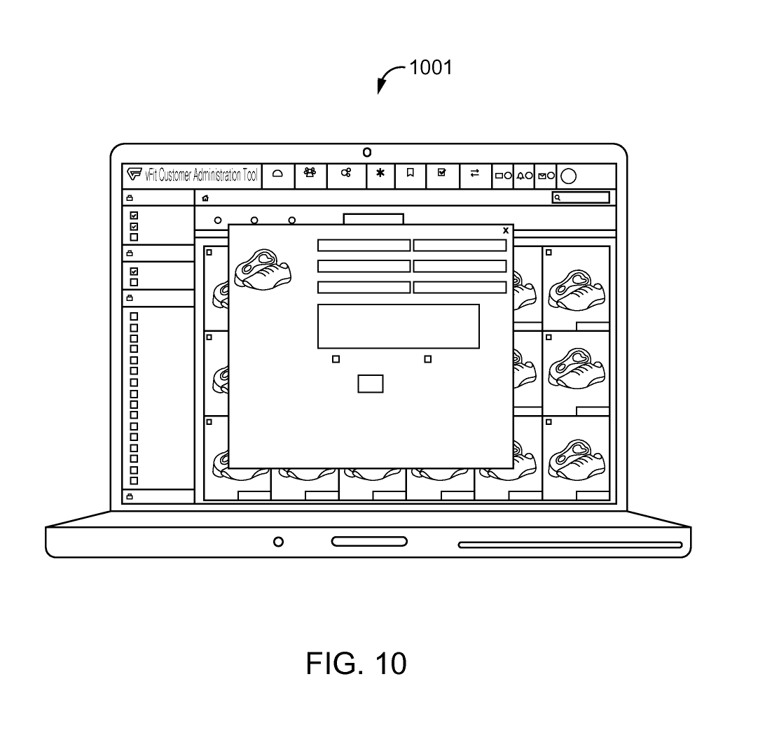

FIG. 10 illustrates recommending 1001 a shoe according to some embodiments. After the matching 901 has been made, the recommendation engine can present selected shoes and information about those shoes including purchase information such as a link to an online seller or any other suitable information.

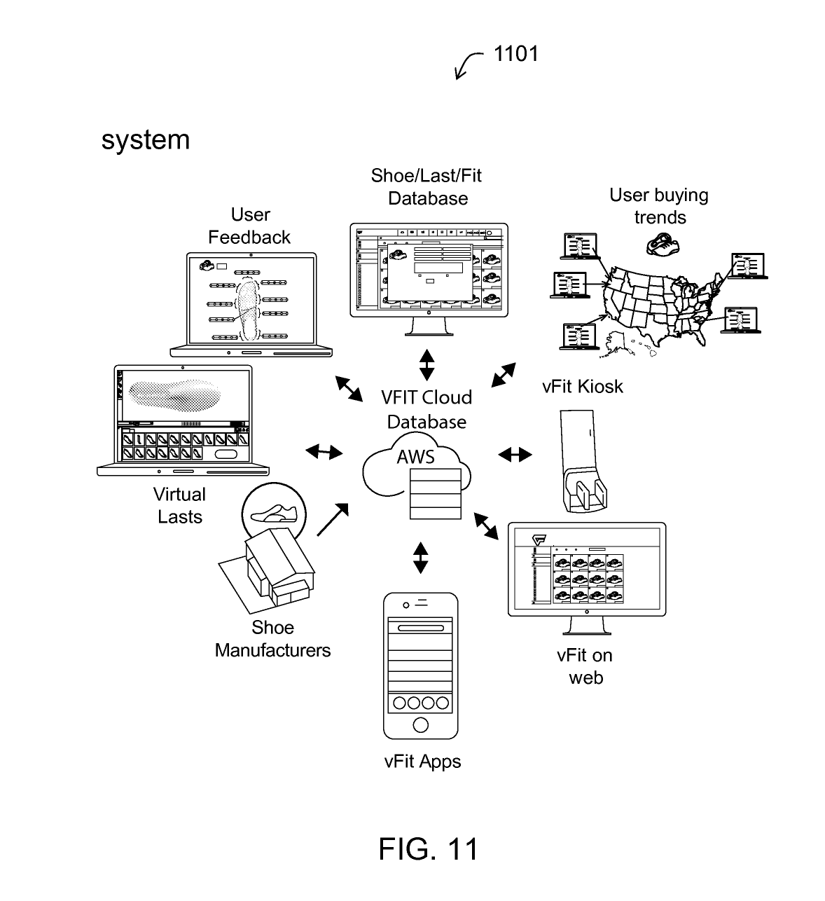

FIG. 11 gives a high level view of a system 1101 for making shoe recommendations based on digital models. Preferably the recommendation engine operates on a server (which may be provided by, for example, Amazon Web Services). The server 1209 can obtain user feedback to enrich the shoe/last/fit database. User buying trends can also influence the recommendation process. 3D coordinate data models of a person's feet are obtained from, for example, in-store kiosks or a device 201 (e.g., smartphone with app). A web front end can be accessed by the user to obtain a recommendation.

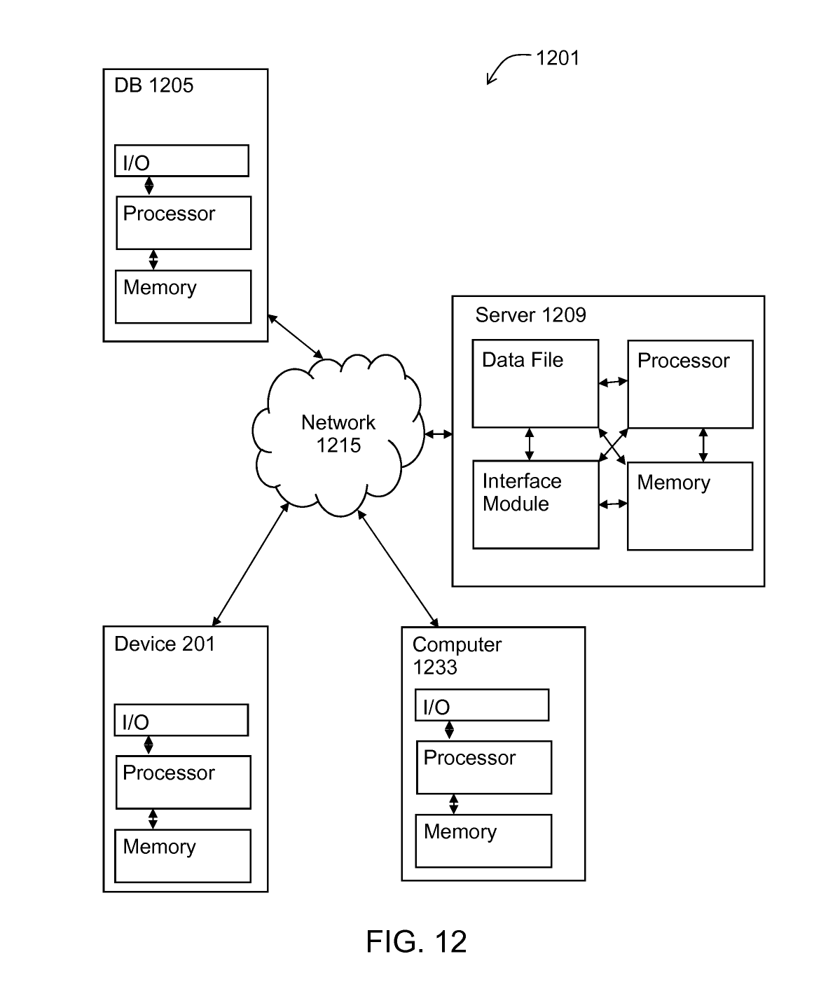

FIG. 12 gives a schematic view of components of a system 1201 according to certain embodiments. Preferably server 1209 hosts data files readable by a processor coupled to a tangible, non-transitory memory. A communications network 1215 (e.g., the Internet) provides access to the server 1209. A database 1205 may be housed independently (or within server system 1209). Device 201 and a user's computer 1233 access system data via communications network 1215. Preferably, each computer device comprises a processor coupled to a memory and one or more input/output devices.

A processor is a computer processor, e.g., one or more silicon chips. Suitable processors include those from Intel (Santa Clara, Calif.). A memory is preferably a computer readable medium and is preferably tangible and non-transitory. Memory may be RAM and/or ROM and can be provided by RAM chips, magnetic disks, solid state drives, other, and combinations thereof. Input/output devices are known in the art and can include one or more of a monitor, keyboard, mouse, trackpad, pointing device, Wi-Fi card, network interface card, cell modem, disc drive, touchscreen, others, and combinations thereof. The depicted system 1201 is operable to perform methods of the invention described herein.

In a preferred embodiment, the database 1205 is populated with last models that are obtained from shoe manufacturers. However, it is recognized that for some shoes, manufacturer digital last models may not be available. In some cases, a shoe may not be represented by a virtual last in the database.

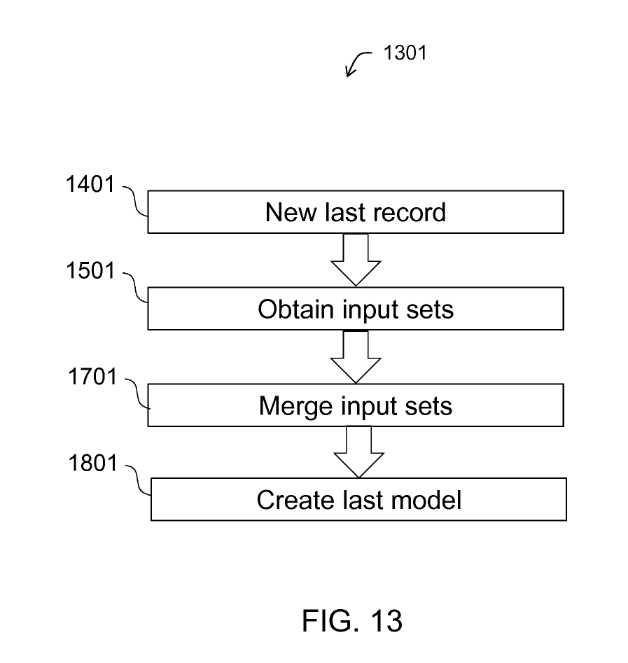

FIG. 13 diagrams a method 1301 for creating a virtual last for the shoe. Where the database 1205 does not contain an adequate, or any last, model for a given shoe, the method 1301 may be employed. A new last record is created 1401. Information for the new last is collected by obtaining 1501 one or a plurality of input sets of data. Preferably, fit information is collected from a plurality of owners of the shoe model in question. The input sets are merged 1701. For example, the multiple sets of different fit information may be averaged by a database engine. A virtual last model is created 1801 based on the averaged or aggregated input from the plurality of owners.

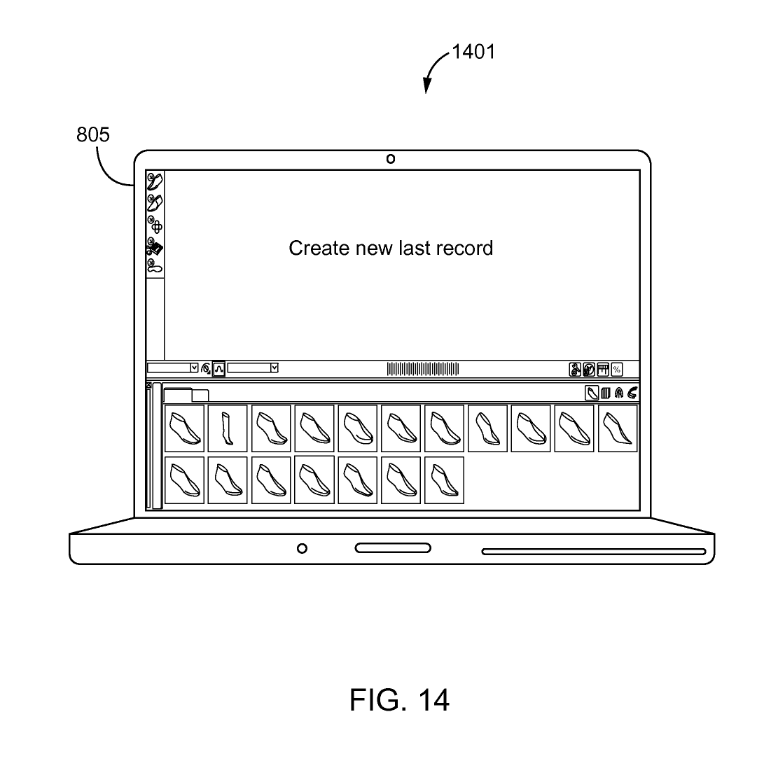

FIG. 14 illustrates a screen for of an interface 805 for creating 1401 a new last record. In a typical or illustrative use case, a person may be interested in a brand and style of shoe, but may discover that the style of shoe is not represented within the database 1205. Thus the person may initiate creation 1401 of a new blank record. People familiar with the shoe may then contribute their information about the fit of the shoe.

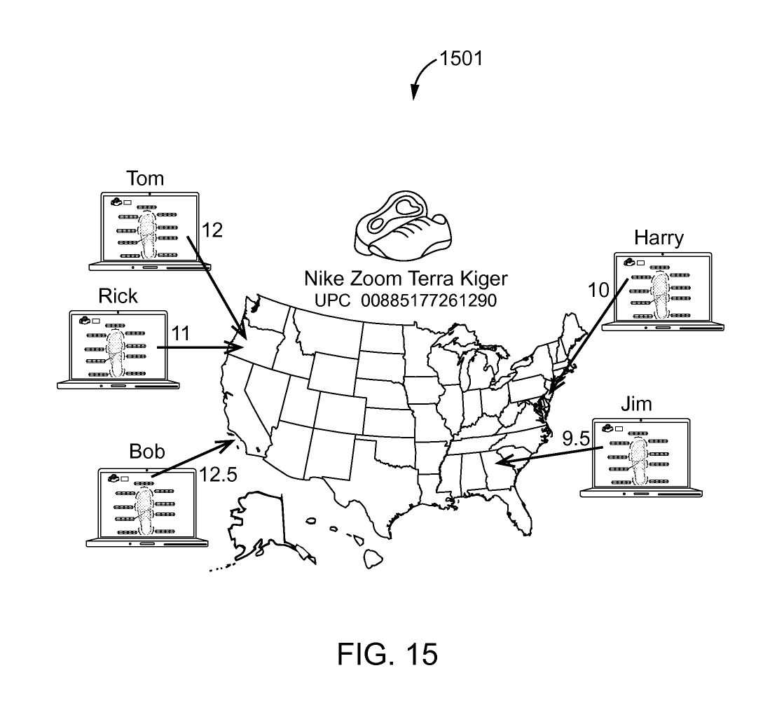

FIG. 15 illustrates how data about a shoe fit may be obtained 1501. In a preferred embodiment, each customer contributing data models their own foot to create a 3D coordinate model according to the process illustrated in FIG. 1. Additionally, each customer provides their own tolerances and comfort data using, e.g., the interface illustrated in FIG. 8.

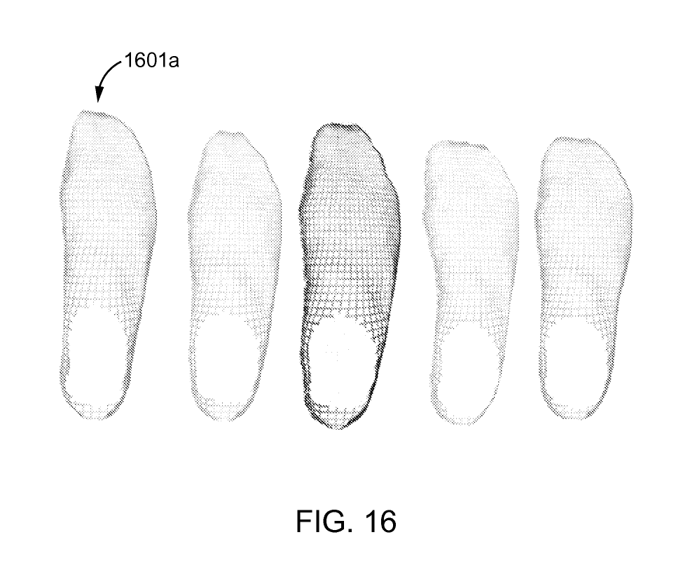

FIG. 16 shows foot models 1601 obtained 1501 from each of a plurality of different people. It can be seen that each model is unique. The system 1201, preferably by action of the processor of server 1209, merges 1701 the foot models 1601, as illustrated in FIGS. 16 & 17.

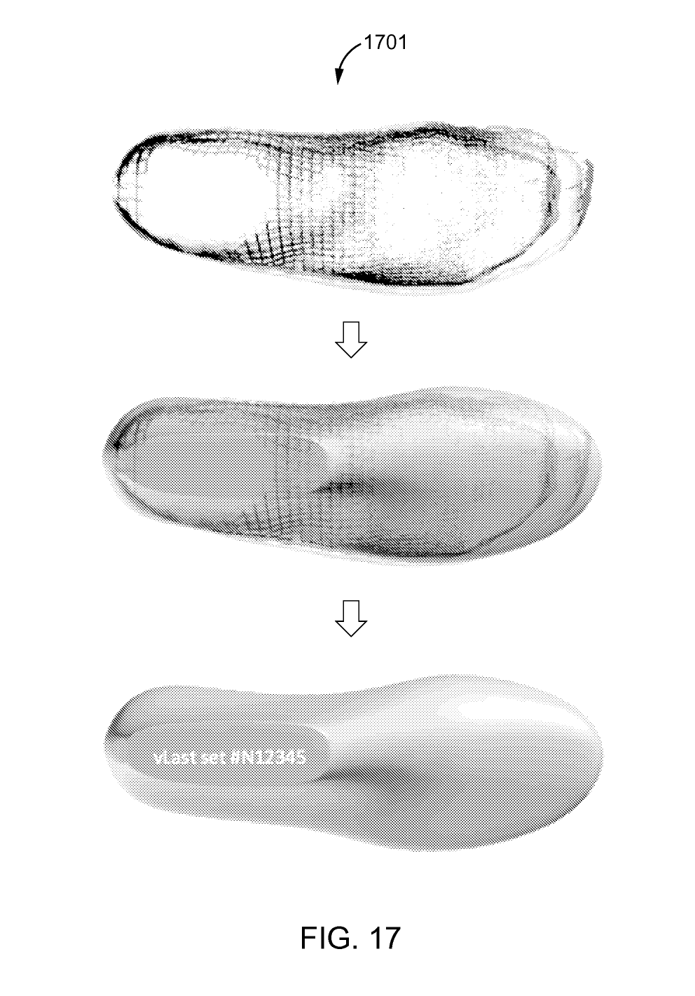

FIG. 17 shows a merged foot model. This merged foot model serves as a basis for creating a new virtual last model for the subject shoe. In some embodiments, all of the contributing models 1601 are averaged. A weighted average may be used, and statistical outliers may optionally be discarded. Weights for the averages may be provided by the tolerances data that is specific to different users and different parts of the foot. As a result, the merged foot model will accurately represent interior dimensions of the subject shoe. That merged foot model is finalized into a virtual last model and, optionally, a set of associated tolerances data.

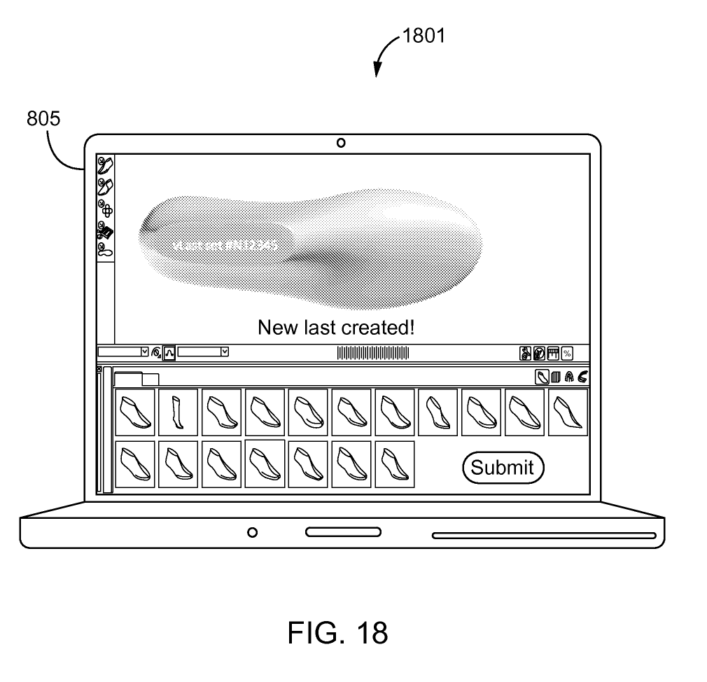

FIG. 18 shows the results of creating 1801 the new virtual last. The database 1205 can now be populated with an entry for the subject shoe, even though no last data was obtained from the manufacturer. The entry in the database can include a full, 3D virtual last for use in subsequent matching operations. The virtual last may then be accessioned into the database and associated with the model of shoe for which it was created, as well as with manufacturer information, size information, market information, or any other suitable information.

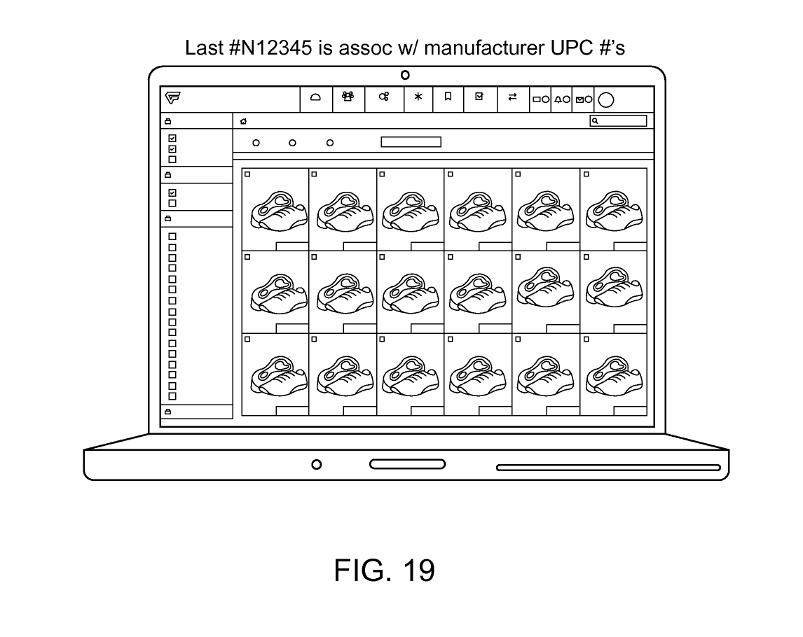

FIG. 19 illustrates that, where it is known that a manufacturer uses one last for a plurality of different shoes, the creation of a virtual last may be used to populate database entries for each of the plurality of shoes.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in Webster's New Twentieth Century Dictionary of the English Language, Unabridged, Second Edition (“Webster's Second”), which dictionary is incorporated by reference.

Finally, all references listed in any Information Disclosure Statement or other information statement filed during the pendency of the application are hereby appended and hereby incorporated by reference; however, as to each of the above, to the extent that such information or statements incorporated by reference might be considered inconsistent with the patenting of this/these invention(s), such statements are expressly not to be considered as made by the Applicant.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

What is claimed is:

1. A method for creating a virtual last for a shoe, the method comprising:
collecting, from a plurality of people, input sets of fit information describing a certain shoe model;
storing the input sets in a computer system comprising a processor coupled to a memory device;
having the processor merge the input sets to create a digital fit model of the shoe model;
creating a database entry for the shoe model in a database within the memory; and
saving the digital fit model as a virtual last model in the database entry.

2. The method of claim 1, wherein the merging step comprises having the processor average the fit information of the input sets.

3. The method of claim 1, further comprising obtaining information that a plurality of different shoes are built to one last and, for each of the plurality of different shoes, saving the digital fit model as a virtual last model in a database entry for that shoe.

4. The method of claim 1, wherein the input sets comprise comfort ratings for different regions of a foot.

5. The method of claim 1, further comprising screening the collected input sets for an outlier and excluding an outlier from the merge step.

6. A system for creating a virtual last for a shoe, the system comprising:
a processor coupled to a memory having stored therein instructions executable to cause the system to:
collect, from a plurality of people, input sets of fit information describing a certain shoe model;
store the input sets in the memory;
merge the input sets to create a digital fit model of the shoe model;
create a database entry for the shoe model in a database within the memory; and
save the digital fit model as a virtual last model in the database entry.

7. The system of claim 6, wherein the merging comprises having the processor average the fit information of the input sets.

8. The system of claim 6, further operable to obtain information that a plurality of different shoes are built to one last and, for each of the plurality of different shoes, save the digital fit model as a virtual last model in a database entry for that shoe.

9. The system of claim 6, wherein the input sets comprise comfort ratings for different regions of a foot.

10. The system of claim 6, further operable to screen the collected input sets for an outlier and exclude an outlier from the merge.

11. A method for recommending a shoe, the method comprising:
obtaining digital data describing a foot of a person and storing the digital data in a computer system comprising a processor coupled to a memory;
causing the processor to match the digital data to a digital last model stored in a database; and
recommending at least one shoe model associated with the digital last to the person.

12. The method of claim 11, wherein the processor matches the digital data by converting the digital data into a set of 3D coordinates and applying a set of tolerances data to an algorithm for comparing the 3D coordinates to dimensions of digital last models.

13. The method of claim 11, wherein obtaining the digital data includes:
providing instructions and an app for execution on a smartphone to the person, the instructions instructing the person to take a plurality of pictures of his or her foot; and
receiving the digital data from the smartphone, the digital data having been obtained by the person following the instructions.

14. The method of claim 13, further comprising using the processor to transform the digital data into a set of 3D coordinates describing the foot.

15. The method of claim 14, wherein the database comprises a plurality of database entries for a corresponding plurality of shoes, each database entry comprising a digital last model, and the method further comprises receiving region-of-foot-specific comfort feedback from a plurality of different consumers and adjusting the database entries according to the comfort feedback prior to causing the processor to match the digital data.

16. A system for recommending a shoe, the system comprising a processor coupled to a memory and operable to:
obtain digital data describing a foot of a person;
store the digital data in the memory;
match the digital data to a digital last model stored in a database; and
recommend at least one shoe model associated with the digital last to the person.

17. The system of claim 16, wherein processor matches the digital data by converting the digital data into a set of 3D coordinates and applying a set of tolerances data to an algorithm for comparing the 3D coordinates to dimensions of digital last models.

18. The system of claim 16, operable to obtain the digital data by:
providing instructions and an app for execution on a smartphone to the person, the instructions instructing the person to take a plurality of pictures of his or her foot; and
receiving the digital data from the smartphone, the digital data having been obtained by the person following the instructions.

19. The system of claim 18, further wherein the processor is operable to transform the digital data into a set of 3D coordinates describing the foot.

20. The system of claim 19, wherein the database comprises a plurality of database entries for a corresponding plurality of shoes, each database entry comprising a digital last model, and the system is further operable to receive region-of-foot-specific comfort feedback from a plurality of different consumers and adjust the database entries according to the comfort feedback prior to causing the processor to match the digital data.

21. An improved system for matching a user's feet with recommended shoes, comprising, in combination;
providing means for grouping continuous coordinates of a three-dimensional coordinate system into one or more groups (comfort zones);
arraying said groups by tolerances generated from pre-existing shoe data and actual foot dimensions;
matching tolerance values; and,
delivering recommendations for shoe style and preferred size to a user.

22. The improved system of claim 21, further comprising a looseness-tightness scale from 1-10, whereby resultory comfort zones support designation of appropriate shoe selections by brand and model.

23. The improved system of claim 22, wherein individual shoe contours are compared with contours of a user's feet.

24. The improved system of claim 23, wherein multiple feedback grouped together as continual points impacts positively tolerance results.

25. The improved system of claim 24, wherein standard statistical deviation is applied to the results and salient information determined to be inaccurate is cleansed and discarded.

26. The improved system of claim 25, wherein said pre-existing shoe data comprises actual 3D shoe last data representing inside contour of a shoe.

27. The systems of any of claims 21-26, wherein said means include at least a smart-device selected from the group of Personal Digital Assistants (PDAs), smart-phones, tablets and related devices capable of capturing, arraying or otherwise displaying arranged digital scans, operatively linked to a database.

28. A process for matching feet to shoe contours, which comprises:
harvesting customer foot sizing data and feedback through a web interface tool;
comparing the same to a database of actual 3D shoe data; and
deriving choices for shoe models allowing for better matched fit.

29. The process of claim 28, wherein the database of 3D shoe data comprises shoe last data representing the inside contour of a shoe.

30. The process of claim 29, wherein said data is based upon data supplied, based upon and/or measured digitally from those who create, distribute and/or retail shoes.

31. The process of claims 28-30, further comprising using a mobile computing device for digital scanning and obtaining foot-size data matching exact contours of a customer's feet.

32. An algorithm for comparing shoe last data to a person's digital foot data as claimed above or below and in this application.

33. A recommendation engine comprising:
means for surveying arrayed shoe data against customer/user's foot data, as described herein and claimed herein or in any U.S. Letters Patent referred to herein.

34. A database which comprises, in combination:
a multiplicity of actual shoe last data representing the inside contour of a shoe, digitally stored, arrayed and effective to compare with the exact outside contour of a specific customer/user's feet digitally scanned.

35. A multi-platform smartphone application and web-based tool which visually compares the shape of a customer's feet with actual data from inside shapes of shoes, and provides recommended choices for the customer.

36. The process, application and tools described, illustrated and claimed herein, further comprising the step of applying standard statistical deviation to resultory data and discarding inaccuracies developed.
